(19) United States
(12) Patent Application Publication
(10) Pub. No.: US 2026/0326386 A1
(43) Pub. Date: Oct. 22, 2026

(54) POWDER BED LASER FUSION ADDITIVE MANUFACTURING PARAMETER ADJUSTMENT

(71) Applicant: International Business Machines Corporation, Armonk, NY (US)

(72) Inventors: Sarbajit Kumar RAKSHIT, Kolkata (IN); Sathya SANTHAR, Chennai (IN); Sridevi KANNAN, Chennai (IN)

(21) Appl. No.: 19/184,365

(22) Filed: Apr. 21, 2025

(51) Int. Cl. B29C 64/393; B22F 10/28; B22F 10/38; B22F 10/85; B29C 64/153; B33Y 50/02

(52) U.S. Cl. CPC B29C 64/393; B22F 10/28; B22F 10/38; B22F 10/85; B29C 64/153; B33Y 50/02

(57) ABSTRACT

In some implementations, a device may receive powder bed laser fusion additive manufacturing emission data including two or more of acoustic data, optical data, olfactory data, or thermal data. The device may identify, based on the powder bed laser fusion additive manufacturing emission data, one or more additive manufacturing object defects. The device may transmit, based on the one or more additive manufacturing object defects, an indication to adjust one or more powder bed laser fusion additive manufacturing parameters.

### BACKGROUND

This disclosure relates to additive manufacturing, and more specifically, to adjusting powder bed laser fusion additive manufacturing parameters.

### SUMMARY

Some aspects described herein relate to a computer-implemented method. The method may include receiving, by a device, powder bed laser fusion additive manufacturing emission data including two or more of acoustic data, optical data, olfactory data, or thermal data. The method may include identifying, by the device, based on the powder bed laser fusion additive manufacturing emission data, one or more additive manufacturing object defects. The method may include transmitting, by the device, based on the one or more additive manufacturing object defects, an indication to adjust one or more powder bed laser fusion additive manufacturing parameters.

Some aspects described herein relate to a computer system. The computer system may include a processor set, one or more computer-readable storage media, and program instructions stored on the one or more computer-readable storage media to cause the processor set to perform operations. The operations may include receiving an indication of one or more laser beam parameters. The operations may include transmitting, based on the one or more laser beam parameters, an indication to adjust one or more emission sensor parameters. The operations may include receiving, in accordance with the one or more emission sensor parameters, powder bed laser fusion additive manufacturing emission data including two or more of acoustic data, optical data, olfactory data, or thermal data. The operations may include identifying, based on the powder bed laser fusion additive manufacturing emission data, one or more additive manufacturing object defects. The operations may include transmitting, based on the one or more additive manufacturing object defects, an indication to adjust one or more powder bed laser fusion additive manufacturing parameters.

Some aspects described herein relate to a computer program product. The computer program product may include one or more computer-readable storage media and program instructions stored on the one or more computer-readable storage media to perform operations. The operations may include receiving powder bed laser fusion additive manufacturing emission data including two or more of acoustic data, optical data, olfactory data, or thermal data. The operations may include identifying, based on the powder bed laser fusion additive manufacturing emission data, one or more additive manufacturing object defects using a machine learning model. The operations may include transmitting, based on the one or more additive manufacturing object defects, an indication to adjust one or more powder bed laser fusion additive manufacturing parameters.

### BRIEF DESCRIPTION OF THE DRAWINGS

FIG. 1 is a diagram of an example computing environment for adjusting one or more powder bed laser fusion additive manufacturing parameters described herein.

FIGS. 2A-2B are diagrams of an example associated with powder bed laser fusion additive manufacturing parameter adjustment as described herein.

FIG. 3 is a diagram of example components of a device associated with adjusting one or more powder bed laser fusion additive manufacturing parameters.

FIG. 4 is a flowchart of an example process associated with powder bed laser fusion additive manufacturing parameter adjustment.

### DETAILED DESCRIPTION

The following detailed description of example implementations refers to the accompanying drawings. The same reference numbers in different drawings may identify the same or similar elements.

Powder fusion is an additive manufacturing technique that enables creating of three-dimensional objects. Powder fusion involves the layer-by-layer fusion of fine powder particles which are fused together to form solid structures. The fine powder particles may be metals or polymers. Initially, a thin layer of powder may be distributed over a build platform, and the thin layer may be selectively fused. For example, metal powder may be fused using selective laser melting or electron-beam melting, or powders of various materials may be fused using binder jetting. In powder bed laser fusion, the powder is fused using a laser beam. The powder bed is built up, cooled, and solidified layer by layer, until a three-dimensional object is complete. Powder fusion is highly precise, with applications in aerospace, healthcare, automotive, and other industries.

Powder bed laser fusion processes often produce objects with various quality issues. For example, pores or voids can form in an object during powder bed laser fusion processes, which can lead to reduced mechanical strength and compromised structural integrity. Additionally, or alternatively, uneven fusion, overheating, and/or oxidation can cause warping, distortion, or surface irregularities, affecting the surface quality and dimensional accuracy of the object. Other defects, such as layer bonding defects, melt pool defects, and residual stresses, can occur, potentially leading to premature failure or degradation of the object. Such quality issues can result in lower precision, increased rejection rates, reduced object lifespan, and/or increased demand for post-production repairs to the object. These results may increase use of memory, processing, and or network resources of a powder bed laser fusion system. For example, the powder bed laser fusion system may repeat a powder bed laser fusion process multiple times to produce a single acceptable object due to low precision or increased rejection rates, re-produce large quantities of objects due to the objects having low lifespans, and/or perform corrective operations on the object after the powder bed laser fusion process has concluded due to post-production repairs. As a result, the powder bed laser fusion system may use processing or memory resources to store and process data involved in carrying out powder bed laser fusion operations to address the quality issues. For example, the powder bed laser fusion system may use processing resources to control powder bed laser fusion, such as the operation of the laser and the powder bed. Additionally, or alternatively, the powder bed laser fusion system may use memory resources during the powder bed laser fusion process to store data, such as data pertaining to the operation of the laser and the powder bed (e.g., laser parameter values and/or powder parameter values).

Implementations described herein enable real-time emission pattern analysis during a powder bed laser fusion process for quality assurance of a resulting object. For example, a powder bed laser fusion system may be integrated with one or more emission sensors configured to detect emissions that are released as a result of an interaction between the laser beam and the powder. The emission sensors may detect various types of emissions, such as acoustic, optical, thermal, olfactory, thermal, or the like. If the emissions deviate from an historical baseline, then the emissions may indicate a quality defect in the object. For example, a combination of emission types may indicate a presence of pores or voids, uneven fusion, overheating, oxidation, layer bonding defects, melt pool defects, residual stresses, or the like. In some examples, the powder bed laser fusion process may be adjusted based on the quality defects. For example, laser power or speed may be adjusted to promote fusion of the powder or reduce heat input to the object. Additionally, or alternatively, powder distribution or layer thickness may be adjusted to improve uniformity of powder distribution. Additionally, or alternatively, a shield gas flow may be adjusted to mitigate oxidation. Thus, various combinations of emission types may indicate quality issues and enable real-time correction or adaptability during the powder bed laser fusion process.

As a result, quality issues in an object produced via powder bed laser fusion may be mitigated and/or corrected in real-time, thereby reducing a likelihood of pores, voids, uneven fusion, or other defects in the object. This reduction in quality issues may help to improve precision, decrease rejection rates, increase object lifespan, and/or lower demand for post-production repairs. Thus, memory and processing resource usage of the powder bed laser fusion system due to quality issues may be reduced. For example, a total quantity of repeated powder bed laser fusion processes, produced objects, and/or corrective operations may be reduced. As a result, the powder bed laser fusion system may conserve processing or memory resources that would otherwise be allocate for storing and processing data involved in carrying out powder bed laser fusion operations to address the quality issues.

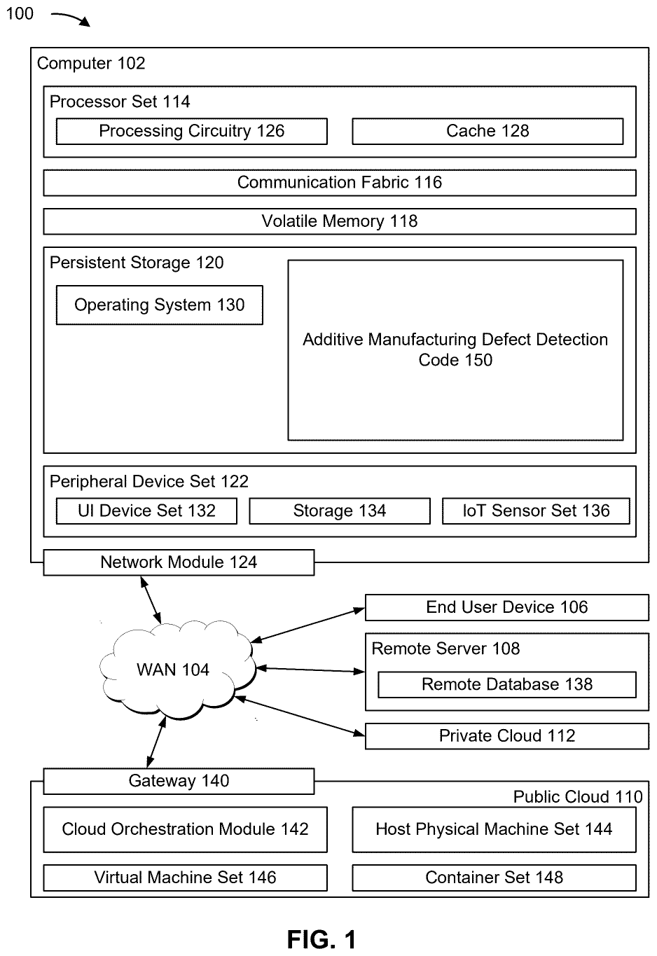

FIG. 1 is a diagram of an example computing environment 100 for adjusting one or more powder bed laser fusion additive manufacturing parameters described herein.

The computing environment 100 contains an example of an environment for the execution of at least some of the computer code involved in performing the inventive methods, such as defect detection code 150. In addition to the defect detection code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the defect detection code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in defect detection code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the defect detection code 150 typically includes at least some of the computer code involved in performing one or more operations described herein. In some implementations, the operations may include receiving powder bed laser fusion additive manufacturing emission data including two or more of acoustic data, optical data, olfactory data, or thermal data; identifying, based on the powder bed laser fusion additive manufacturing emission data, one or more additive manufacturing object defects; and transmitting, based on the one or more additive manufacturing object defects, an indication to adjust one or more powder bed laser fusion additive manufacturing parameters. In some implementations, the operations may include receiving an indication of one or more laser beam parameters; transmitting, based on the one or more laser beam parameters, an indication to adjust one or more emission sensor parameters; receiving, in accordance with the one or more emission sensor parameters, powder bed laser fusion additive manufacturing emission data including two or more of acoustic data, optical data, olfactory data, or thermal data; identifying, based on the powder bed laser fusion additive manufacturing emission data, one or more additive manufacturing object defects; and transmitting, based on the one or more additive manufacturing object defects, an indication to adjust one or more powder bed laser fusion additive manufacturing parameters. In some implementations, the operations may include receiving powder bed laser fusion additive manufacturing emission data including two or more of acoustic data, optical data, olfactory data, or thermal data; identifying, based on the powder bed laser fusion additive manufacturing emission data, one or more additive manufacturing object defects using a machine learning model; and transmitting, based on the one or more additive manufacturing object defects, an indication to adjust one or more powder bed laser fusion additive manufacturing parameters.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

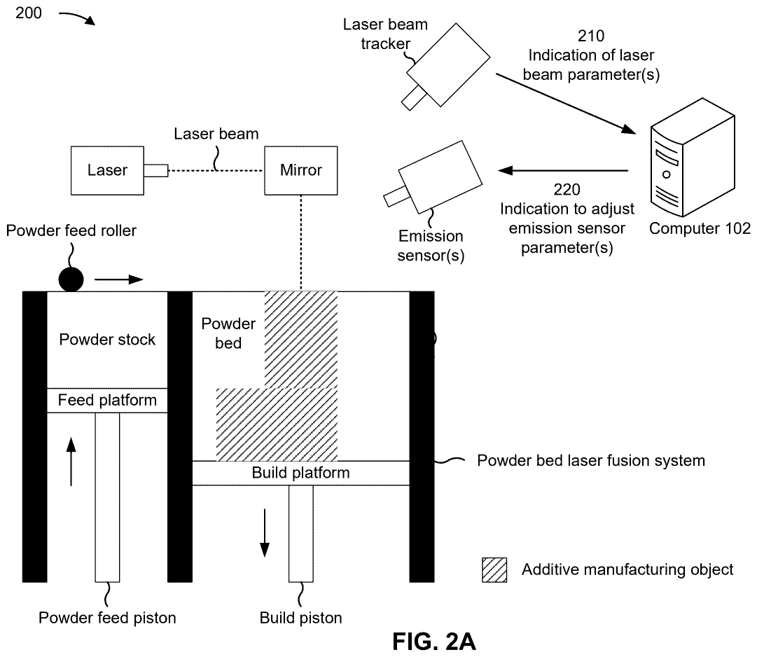

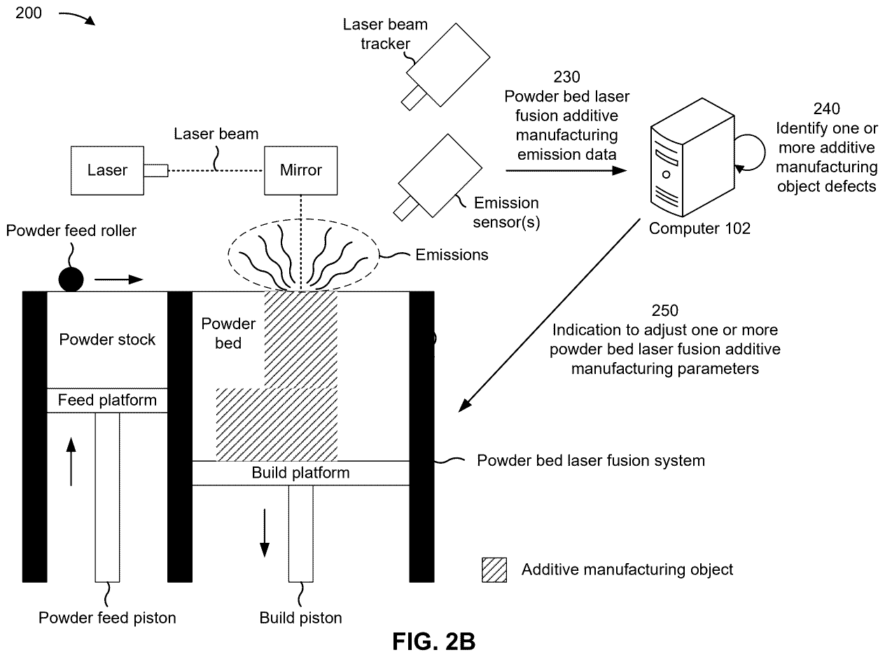

FIGS. 2A-2B are diagrams of an example 200 associated with powder bed laser fusion additive manufacturing parameter adjustment as described herein.

Example 200 includes a powder bed laser fusion system configured to produce an additive manufacturing object layer-by-layer. The powder bed laser fusion system includes a laser, a mirror (e.g., a scanning mirror), a powder feed roller, a powder stock, a powder feed platform (shown in FIGS. 2A and 2B as a “feed platform”), a powder feed piston, a powder bed, a build platform, and a build piston. The powder feed roller is used to feed powder from the powder stock supported by the feed platform to the powder bed supported by the build platform. The powder may be spread evenly in a thin layer in the powder bed. The laser may generate a laser beam, which is directed at the powder bed via the mirror. As an orientation of the mirror changes, the laser beam may scan the powder in a predetermined pattern. The laser beam melts the powder, fusing the powder in the predetermined pattern and thereby creating a single layer of the additive manufacturing object. The powder feed piston may raise the powder feed platform, the build piston may lower the build platform, and the powder feed roller may feed another layer of powder to the powder bed, where the laser beam may fuse the powder into another layer of the additive manufacturing object. This process may be repeated, layer-by-layer, until the entire additive manufacturing object is formed.

The computer 102 may be communicatively coupled to the powder bed laser fusion system. For example, the computer 102 may communicate with the powder bed laser fusion system over wired and/or wireless communication links using the communication fabric 116, the network module 124, or the like. The computer 102 may control various aspects of the operation of the powder bed laser fusion system, such as powder bed laser fusion to produce an additive manufacturing object. In some examples, the computer 102 may be a part of the powder bed laser fusion system, and may correspond to the control system of the powder bed laser fusion system (e.g., the computer 102 may be embedded in the form factor of the powder bed laser fusion system). In some examples, the computer 102 may be located remote from the powder bed laser fusion system.

With reference to FIG. 2A, as shown by reference number 210, a laser beam tracker may transmit, and the computer 102 may receive, an indication of one or more laser beam parameters. The laser beam tracker may collect data relating to one or more properties of the laser beam, and the one or more laser beam parameters may indicate these properties. In some examples, the one or more laser beam parameters may include real-time updates relating to the one or more properties of the laser beam. For example, the laser beam tracker may transmit indications of one or more laser beam parameters dynamically and/or continuously. In some examples, the laser beam tracker may collect the data via one or more cameras that are trained on the laser beam. Additionally, or alternatively, the laser beam tracker may collect the data (e.g., indicating an orientation of the mirror) from the mirror or a controller of the mirror. Additionally, or alternatively, the laser beam tracker may collect the data from the laser or a controller of the laser. In some examples, a laser beam tracking module (e.g., a software module) at the computer 102 may monitor the one or more properties of the laser beam using the one or more laser beam parameters.

In some aspects, the one or more laser beam parameters include one or more laser beam position parameters, one or more laser beam orientation parameters, or one or more laser beam intensity parameters. The one or more laser beam position parameters may indicate a location of the laser beam on the powder bed. For example, the location of the laser beam on the powder bed may be indicated by an x-coordinate (e.g., a horizontal position of the laser beam on the powder bed), a y-coordinate (e.g., a vertical position of the laser beam on the powder bed), and/or a z-coordinate (e.g., a height or depth position of the laser beam on the powder bed). The one or more laser beam orientation parameters may indicate an angular displacement of the laser beam relative to a reference axis. For example, the angular displacement of the laser beam may be indicated by a polar angle (e.g., an angle between the laser beam and a polar axis) and/or an azimuthal angle (e.g., an angle of rotation of the laser beam around the polar axis). The one or more laser beam intensity parameters may indicate an amount of power per unit area of the powder bed applied by the laser beam. The laser beam tracker may determine the one or more laser beam position parameters, one or more laser beam orientation parameters, or one or more laser beam intensity parameters using data collected from one or more cameras, the mirror or the controller of the mirror, the laser and/or the controller of the laser, or the like.

As shown by reference number 220, the computer 102 may transmit, and one or more emission sensors may receive, based on the one or more laser beam parameters, an indication to adjust one or more emission sensor parameters. The emission sensor(s) may include acoustic sensors (e.g., microphone-based sound sensors), optical sensors (e.g., camera-based light sensors), olfactory sensors (e.g., smell sensors, such as electronic noses), and/or thermal sensors (e.g., heat emission sensors, such as thermal imaging cameras, pyrometers, thermometers, or the like). For example, the emission sensor(s) (e.g., “emission measurement modules”) may be configured to monitor acoustic, optical, olfactory, or thermal emissions from the powder bed laser fusion system. The one or more emission sensor parameters may be settings of configurations that control an operation of the emission sensor(s). In some examples, the one or more emission sensor parameters may include a position and/or an orientation of the emission sensor(s) relative to a location of the laser beam on the powder bed, sampling time information (e.g., when and/or how often the emission sensor(s) are to sample emission data), one or more threshold values above or below which the emission sensors are to transmit emission data to the computer 102, a focus of the one or more emission sensor parameters, or the like. In some examples, adjusting the one or more emission sensor parameters may dynamically align the emission sensors based on the direction (and/or a target direction) of the laser beam. For example, adjusting the one or more emission sensor parameters may dynamically align the emission sensors with the location (and/or a target location) of the laser beam on the powder bed. The location on the powder bed where the laser beam is applied for powder fusion (e.g., where the laser beam and the powder bed interface) may be referred to as a “fusion point,” “fusion zone,” “laser fusion zone,” “fusion area,” or “laser fusion area.” For example, the computer 102 may identify the fusion point and automatically calculate, based on the fusion point, a target position and/or orientation of the emission sensor(s). In some examples, the one or more emission sensor parameters may cause one or more precision actuators to reposition the emission sensor(s). In some examples, the emission sensors may be integrated onto an emission sensor array, and the one or more emission sensor parameters may configure the emission sensor array (e.g., the one or more emission sensor parameters may configure a position or orientation (e.g., an angle) of the emission sensor array, and/or of individual emission sensors on the emission sensor array). For example, adjusting the one or more emission sensor parameters may align the emission sensor array and/or configure the emission sensor array to monitor emissions during a powder bed laser fusion process. In some examples, each emission sensor may be mounted on a pivotable system that aligns the emission sensor(s) with the fusion point. In examples where the one or more laser beam parameters include real-time updates, the computer 102 may identify updated fusion points as the location of the laser beam changes, and dynamically adjust the one or more emission sensor parameters accordingly in real-time.

With reference to FIG. 2B, as shown by reference number 230, the emission sensor(s) may transmit, and the computer 102 may receive, powder bed laser fusion additive manufacturing emission data. The powder bed laser fusion additive manufacturing emission data may include data relating to emissions generated and released due to a powder bed laser fusion process (e.g., due to laser interactions with the metal powder). For example, the emissions may be released from, or locally to, the fusion point. In some examples, the computer 102 may receive the powder bed laser fusion additive manufacturing emission data in real-time (e.g., during a powder bed laser fusion process). For example, the emission sensor(s) and the computer 102 may be part of a closed-loop monitoring system that enables the computer 102 to perform real-time monitoring of patterns in the powder bed laser fusion additive manufacturing emission data. In some aspects, the powder bed laser fusion additive manufacturing emission data may include two or more of acoustic data, optical data, olfactory data, or thermal data. For example, the acoustic sensor(s) may collect (e.g., detect or gather) the acoustic data (e.g., data relating to sound waves), and transmit the acoustic data to the computer 102. Additionally, or alternatively, the optical sensor(s) may collect the optical data (e.g., data relating to light patterns), and transmit the optical data to the computer 102. Additionally, or alternatively, the olfactory sensor(s) may collect the olfactory data (e.g., data relating to gas compositions), and transmit the olfactory data to the computer 102. Additionally, or alternatively, the thermal sensor(s) may collect the thermal data (e.g., data relating to thermal gradients, ionized particles or plasma, spatter patterns, or the like), and transmit the thermal data to the computer 102.

In some aspects, the computer 102 may receive the powder bed laser fusion additive manufacturing emission data in accordance with the one or more emission sensor parameters. For example, the emission sensors may collect the powder bed laser fusion additive manufacturing emission data while the emission sensors are in a given position and/or orientation as indicated by the one or more emission sensor parameters. For example, the emission sensors may, based on the one or more emission sensor parameters, be dynamically positioned near and/or oriented toward (e.g., focused on) the fusion point while the emissions are generated at the fusion point. In some examples, the emission sensors may be arranged during the collection so as to reduce or minimize interference from neighboring emission sensors and increase or maximize exposure to one or more sources of the emissions (e.g., the fusion point).

As shown by reference number 240, the computer 102 may identify, based on the powder bed laser fusion additive manufacturing emission data, one or more additive manufacturing object defects. For example, the computer 102 may identify the additive manufacturing object defect(s) by analyzing variations in the powder bed laser fusion additive manufacturing emission data. In some examples, the computer 102 may monitor the powder bed laser fusion additive manufacturing emission data for deviations (e.g., anomalies) from a baseline. The baseline may represent expected powder bed laser fusion additive manufacturing emission data under defect-free operating conditions. The baseline, or deviation from the baseline, may be configured manually or identified autonomously. In some examples, a deviation threshold may be configured or identified such that a deviation from the baseline that is greater than the deviation threshold may indicate a presence of the one or more additive manufacturing object defects. In some examples, the computer 102 (e.g., an anomaly detection software module of the computer 102) may detect the deviation from the baseline. For example, the computer 102 may sample the powder bed laser fusion additive manufacturing emission data and identify the deviation. In some examples, the deviation may occur rapidly (e.g., a short length of time). Upon detecting the deviation, the computer 102 may identify the one or more additive manufacturing object defects. The one or more additive manufacturing object defects may be current and/or predicted quality issues (or types of the quality issues) with the additive manufacturing object produced by the powder bed laser fusion system. For example, the computer 102 may identify the one or more additive manufacturing object defects based on an individual deviation associated with a single sensor feed (e.g., a deviation in the acoustic data, a deviation in the optical data, a deviation in the olfactory data, or a deviation in the thermal data), or based on a combination of deviations associated with respective sensor feeds. In some examples, the computer 102 (e.g., a real-time emission analysis software module of the computer 102) may perform a real-time quality evaluation of the powder bed laser fusion additive manufacturing emission data. For example, the computer 102 may, in real-time, monitor the laser fusion additive manufacturing emission data, continuously analyze the powder bed laser fusion additive manufacturing emission data (e.g., by comparing one or more patterns of the powder bed laser fusion additive manufacturing emission data to baseline patterns), and detect any deviations in the powder bed laser fusion additive manufacturing emission data that indicate potential quality issues through a powder bed laser fusion process.

In some aspects, the one or more additive manufacturing object defects include one or more of keyhole pore formation, a layer bonding defect, a melt pool defect, surface irregularity, layer inconsistency, a structural integrity defect, uneven fusion, overheating, residual stress, or warping. Keyhole pore formation may refer to a deep, narrow cavity (a “keyhole”) created by the laser beam in the powder bed, which can lead to the formation of pores (e.g., voids) in the additive manufacturing object. Keyhole pores may be caused by high laser power or a low scan speed of the laser beam. Layer bonding defects may refer to cases where adjacent layers of the additive manufacturing object do not bond properly, resulting in a weak or delaminated joint. Layer bonding defects may be caused by inadequate laser power, among other examples. A melt pool defect may refer to an improperly controlled melt pool (e.g., powder melted by the laser beam) that results porosity, lack of fusion, excessive melt pool size, or the like. Melt pool defects may be caused by an incorrect laser power, scan speed, or high powder bed temperature (because heat can influence melt pool dynamics). Surface irregularities may refer to a rough or uneven surface of the additive manufacturing object. Surface irregularities may be caused by inadequate powder bed leveling, incorrect laser power, or the like. Layer inconsistency may refer to an inconsistent thickness or density of layers of the additive manufacturing object, resulting in layer delamination or inconsistent mechanical properties, among other examples. Layer inconsistency may be caused by inadequate powder bed leveling, incorrect laser power, or variations in powder feed rate. A structural integrity defect may refer to a feature of the additive manufacturing object that weakens structural integrity of the additive manufacturing object, resulting in reduced mechanical durability. A structural integrity defect may be caused by oxidation, inadequate laser power, insufficient layer bonding, porosity, cracks, or the like. Uneven fusion may refer to non-uniform fusion of the powder, resulting in inconsistent mechanical properties of the additive manufacturing object. Uneven fusion may be caused by incorrect laser power, scan speed, powder bed temperature, or the like. Overheating may refer to overly high temperatures experienced by the powder bed or the additive manufacturing object, resulting in distortion or degradation of the additive manufacturing object. Overheating may be caused by excessive laser power, inadequate cooling, poor thermal management, or the like. Residual stress may refer to stresses that become trapped within the additive manufacturing object, resulting in damage to the additive manufacturing object, such as cracks. Residual stress may be caused by uneven cooling, among other examples. Warping may refer to a deformation of the additive manufacturing object, and may be caused by uneven cooling or residual stresses. The computer 102 may, based on the identified deviations in various types of emission data, the proposed system will predict the types of (potential) defects that may occur in the regions of the recently fused area. Different types of additive manufacturing object defects may correspond to respective emission patterns in various emission data feeds. For example, the computer 102 may identify keyhole pore formation or a layer bonding defect based on the acoustic data.

Additionally, or alternatively, the computer 102 may identify layer inconsistency based on acoustic data or the thermal data. For example, the thermal data may indicate spatter patterns, which may impact the layer inconsistency (e.g., surface roughness). Additionally, or alternatively, the computer 102 may identify a melt pool defect based on the optical data or the thermal data. For example, the thermal data may indicate a level of stability of plasma (e.g., plasma stability may indicate consistent melt pool behavior, and rapid changes in plasma may suggest defects). Additionally, or alternatively, the computer 102 may identify a surface irregularity based on the optical data. Additionally, or alternatively, the computer 102 may identify a structural integrity defect based on the olfactory data (e.g., by detecting oxidation or binder burn-off). Additionally, or alternatively, the computer 102 may identify uneven fusion, overheating, residual stress (e.g., anticipated residual stress), or warping based on the optical data or the thermal data (e.g., by detecting oxidation or binder burn-off).

In some aspects, the computer 102 may identify one or more additive manufacturing object defect zones associated with the one or more additive manufacturing object defects. An additive manufacturing object defect zone may be an area or volume of the additive manufacturing object where a defect (e.g., a current or potential quality issue) has occurred, is occurring, or is predicted to occur. The one or more additive manufacturing object defect zones may be associated with the one or more additive manufacturing object defects in that the one or more additive manufacturing object defects have occurred, are occurring, or are predicted to occur in the one or more additive manufacturing object defect zones. The computer 102 may identify the additive manufacturing object defect zones based on a latency associated with computation (e.g., a length of time between receiving the powder bed laser fusion additive manufacturing emission data and identifying the one or more additive manufacturing object defects). For example, upon calculating the latency, the computer 102 may identify the additive manufacturing object defect zones by determining when the powder bed laser fusion additive manufacturing emission data was received. For example, the computer 102 may identify the one or more additive manufacturing object defect zones based on the fusion point at the time when the powder bed laser fusion additive manufacturing emission data was collected or received. For example, the one or more additive manufacturing object defect zones may include, or be local to, a previous fusion point (e.g., a recently fused area or recently completed section of the powder bed). Thus, the computer 102 may determine that the one or more additive manufacturing object defects have occurred or are occurring in the additive manufacturing object defect zones. Additionally, or alternatively, the computer 102 may predict that the one or more additive manufacturing object defects will occur at a future fusion point (e.g., an upcoming fused area or upcoming completed section of the powder bed). In some examples, the computer 102 may generate, based on the powder bed laser fusion additive manufacturing emission data, a defect map of the one or more additive manufacturing object defect zones. For example, the computer 102 may generate the map in real-time. In some examples, the map may be a three-dimensional map that indicates one or more physical locations of the one or more additive manufacturing object defect zones within, or with respect to, the additive manufacturing object.

In some aspects, the computer 102 may identify the one or more additive manufacturing object defects using a machine learning model. In some examples, the machine learning model may be trained based on historical powder bed laser fusion additive manufacturing emission data (e.g., previously captured emission data patterns) and correlated additive manufacturing object defects. For example, the machine learning model may use supervised learning to identify relationships between the historical powder bed laser fusion additive manufacturing emission data and the correlated additive manufacturing object defects. Upon deployment, the machine learning model may detect and predict the one or more additive manufacturing object defects based on the powder bed laser fusion additive manufacturing emission data (e.g., by analyzing deviations of the powder bed laser fusion additive manufacturing emission data from one or more historical baseline patterns). For example, the machine learning model may predict potential deviations in the powder bed laser fusion additive manufacturing emission data, and, thus, in the quality of the additive manufacturing object. Additionally, or alternatively, the machine learning model may, based on the powder bed laser fusion additive manufacturing emission data, identify and classify probabilities that the one or more additive manufacturing object defects are present. In some examples, the machine learning model may be referred to as a “predictive model” or a “predictive quality detection model.” In some examples, the computer 102 may feed the powder bed laser fusion additive manufacturing emission data into the machine learning model in real-time. For example, the computer 102 may continuously feed the powder bed laser fusion additive manufacturing emission data into the machine learning model, and the machine learning model may analyze deviations (e.g., irregularities) in real-time and identify early signs of the one or more additive manufacturing object defects. In some examples, the computer 102 may perform self-learning to adapt to various changes in patterns of the powder bed laser fusion additive manufacturing emission data and/or the one or more additive manufacturing object defects. For example, the machine learning model may learn from feedback regarding real-time predictions of the machine learning model (e.g., the machine learning model may learn from an accuracy of the machine learning model in predicting the one or more additive manufacturing object defects based on the powder bed laser fusion additive manufacturing emission data). The machine learning model may learn from this feedback and continuously fine-tune a capability of the machine learning model to predict additive manufacturing object defects in real-time (e.g., during a powder bed laser fusion process).

As shown by reference number 250, the computer 102 may transmit, and the powder bed laser fusion system may receive, based on the one or more additive manufacturing object defects, an indication to adjust one or more powder bed laser fusion additive manufacturing parameters. The one or more powder bed laser fusion additive manufacturing parameters may be settings, factors, or conditions that control a powder bed laser fusion process. For example, the computer 102 may continuously and/or dynamically adjust the one or more powder bed laser fusion additive manufacturing parameters in response to detected deviations to address (e.g., proactively mitigate) the one or more additive manufacturing object defects. For example, the indication to adjust the one or more powder bed laser fusion additive manufacturing parameters may cause the powder bed laser fusion system to adapt in real-time to perform corrective action to prevent future additive manufacturing object defects from occurring (or prevent additive manufacturing object defects from continuing to occur) later in the powder bed laser fusion process and/or subsequent powder bed laser fusion processes, correct emerging additive manufacturing object defects (e.g., correct quality issues that have already occurred), and/or mitigate additive manufacturing object defects that are occurring in the one or more additive manufacturing object defect zones. Adjusting the powder bed laser fusion additive manufacturing parameters based on the powder bed laser fusion additive manufacturing emission data may form a low-latency feedback loop for rapid powder bed laser fusion processes.

In some aspects, the one or more powder bed laser fusion additive manufacturing parameters include one or more of one or more laser beam parameters, one or more shield gas parameters, or one or more powder distribution parameters. For example, the computer 102 may dynamically adjust (e.g., selectively re-align) the one or more laser beam parameters, the one or more shield gas parameters, and/or one or more powder distribution parameters. The one or more laser beam parameters may include settings, factors, or conditions that control the laser and/or laser beam. For example, the one or more laser beam parameters may re-melt one or more additive manufacturing object defect zones, which may help to enforce a uniform heating and/or controlled cooling to address cracks or residual stresses throughout the additive manufacturing object. The one or more shield gas parameters may include settings, factors, or conditions that control a shield gas. A shield gas (or “shielding gas”) may be an inert or semi-inert gas that protects the fusion point from oxidation. In some examples, the powder bed laser fusion system may include robust connectors and shield gas release capabilities. The computer 102 may adjust the one or more shield gas parameters based on a target laser beam temperature for powder fusion, powder material specifications, detected or predicted oxidation levels, or the like. For example, the computer 102 may dynamically adjust the one or more shield gas parameters such that oxidation at the fusion point is prevented, reduced, or eliminated, thereby protecting the fusion point and avoiding weaknesses in layer joins that would otherwise have been caused by oxidation. In some examples, the shield gas may help to prevent distortion of the powder bed laser fusion additive manufacturing emission data. In some examples, the computer 102 (e.g., a machine learning model) may predict the shield gas parameters based on historical shield gas data. For example, a machine learning model may be trained, using historical data pertaining to shield gas, to output the shield gas parameters based on an input, which may include the powder bed laser fusion additive manufacturing emission data and/or data pertaining to the one or more additive manufacturing object defects. The one or more powder distribution parameters may include settings, factors, or conditions that control powder distribution of the powder within or on the powder bed. In some examples, a powder layer distribution module (e.g., a software module) of the computer 102 may receive an indication of the one or more additive manufacturing object defects (e.g., one or more types of the additive manufacturing object defects), and, using historical learning, identify the one or more powder distribution parameters. For example, a machine learning model may be trained, using historical data pertaining to powder distribution, to output the powder distribution parameters based on an input, which may include the powder bed laser fusion additive manufacturing emission data and/or data pertaining to the one or more additive manufacturing object defects.

In some aspects, the one or more laser beam parameters may include one or more of a laser beam power parameter, a laser beam focal length parameter, or a laser beam scan speed parameter. The laser beam power parameter may be a setting that controls the amount of power (or intensity) of the laser beam. The laser beam focal length parameter may be a setting that controls a distance between the laser or mirror and a focal point of the laser beam. The focal point is a location where the laser beam converges to a smallest diameter. Thus, the computer 102 may control a thickness of the laser beam. The laser beam scan speed parameter may control a rate at which the laser beam moves across the powder bed. In some examples, the computer 102 may dynamically modify, based on the one or more additive manufacturing object defects (e.g., based on one or more identified deviations), the laser beam power parameter, the laser beam focal length parameter, and/or the laser beam scan speed parameter. For example, the computer 102 may increase laser intensity, which may reinforce under-fused sections, or may adjust focal points, which may improve precision. Additionally, or alternatively, the one or more laser beam parameters may include a laser beam alignment (e.g., laser beam position and/or orientation). In some aspects, the one or more shield gas parameters include one or more of a shield gas flow parameter or a shield gas composition parameter. The shield gas flow parameter may be a setting that controls a rate at which the shield gas is delivered to the fusion point. The shield gas composition parameter may be a setting that controls a type and proportion of gases that make up the shield gas. In some examples, a shield gas flow module (e.g., a software module) of the computer 102 may continuously control the shield gas flow and thereby protect fusion quality by mitigating thermal or chemical inconsistencies. For example, if patterns of the powder bed laser fusion additive manufacturing emission data indicates overheating or oxidation, then the computer 102 may automatically adjust (e.g., increase) the shield gas flow, which may reduce temperature and contamination. In some aspects, the one or more shield gas parameters include one or more of a powder distribution thickness parameter or a powder distribution feed rate parameter. The powder distribution thickness parameter may be a setting that controls the thickness of a powder layer deposited on the build platform. The powder distribution feed rate parameter may be a setting that controls a rate at which powder is fed from the feed platform to the build platform.

Transmitting the indication to adjust the one or more powder bed laser fusion additive manufacturing parameters based on the one or more additive manufacturing object defects may help to reduce additive manufacturing object defects, thereby helping to improve or enhance manufacturing product quality. For example, the indication to adjust the one or more powder bed laser fusion additive manufacturing parameters may help to improve powder bed laser fusion process stability and manufacturing precision, decrease rejection rates, increase object lifespan, and/or lower demand for post-production repairs. Thus, memory and processing resource usage of the powder bed laser fusion system due to additive manufacturing object defects may be reduced. For example, a total quantity of repeated powder bed laser fusion processes, produced objects, and/or corrective operations may be reduced. As a result, the powder bed laser fusion system may conserve processing or memory resources that would otherwise be allocate for storing and processing data involved in carrying out powder bed laser fusion operations to address the additive manufacturing object defects.

Receiving the powder bed laser fusion additive manufacturing emission data in accordance with the one or more emission sensor parameters may help to improve a quality of the powder bed laser fusion additive manufacturing emission data. For example, the emission sensor parameters may cause the emission sensors to be placed strategically around the fusion point without obstructing the powder bed laser fusion process. Thus, the emission sensors may, based on the one or more emission sensor parameters, accurately detect or capture precise, high-quality, real-time emission data from the fusion point. Additionally, or alternatively, the emission sensors may improve emission data collection based on location(s) where emissions are strong and/or indicative of a presence quality issues. Accordingly, the powder bed laser fusion additive manufacturing emission data may enable accurate, real-time identification of the one or more additive manufacturing object defects, which may result in further improvements in manufacturing product quality, and, thus, further reduction in processing or memory resource usage storing and processing data involved in carrying out powder bed laser fusion operations to address the additive manufacturing object defects.

FIGS. 2A-2B are provided as an example. Other examples may differ from what is described with regard to FIGS. 2A-2B.

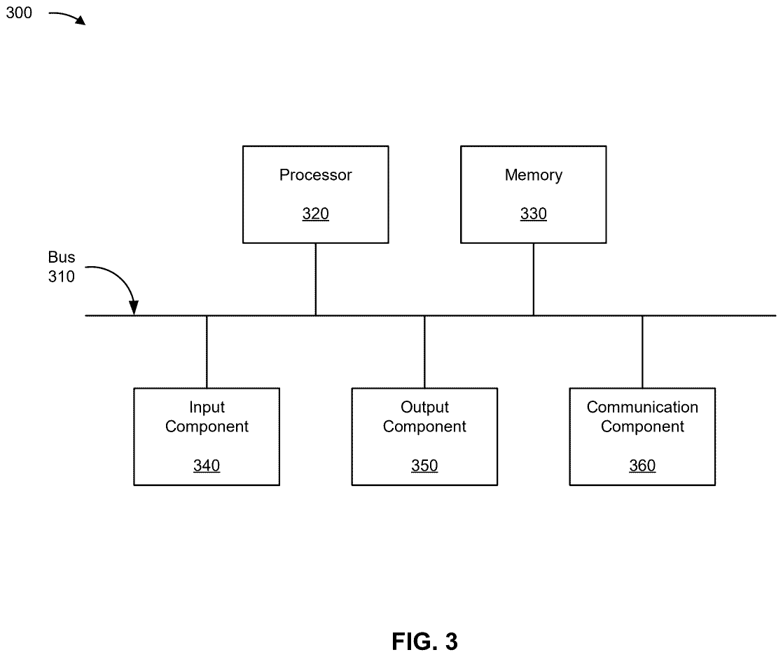

FIG. 3 is a diagram of example components of a device 300 associated with adjusting one or more powder bed laser fusion additive manufacturing parameters. The device 300 corresponds to one or more of the computer 102, EUD 106, the remote server 108, the public cloud 110, and/or the private cloud 112. In some implementations, the computer 102, EUD 106, the remote server 108, the public cloud 110, and/or the private cloud 112 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as RAM, read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

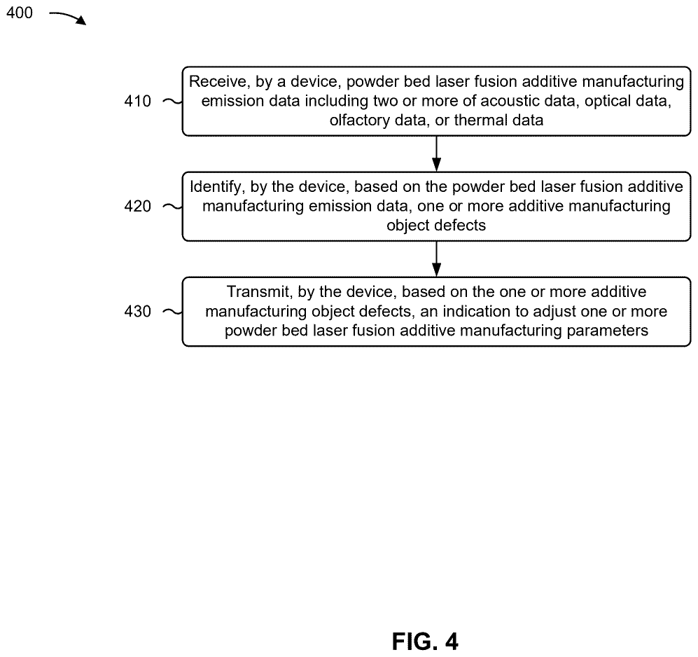

FIG. 4 is a flowchart of an example process 400 associated with powder bed laser fusion additive manufacturing parameter adjustment. One or more process blocks of FIG. 4 are performed by a device (e.g., computer 102) and/or by another device or a group of devices separate from or including the device, such as a EUD (e.g., EUD 106), a remote server (e.g., remote server 108), a public cloud (e.g., public cloud 110) and/or a private cloud (e.g., private cloud 112). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving powder bed laser fusion additive manufacturing emission data including two or more of acoustic data, optical data, olfactory data, or thermal data (block 410). For example, the device may receive powder bed laser fusion additive manufacturing emission data including two or more of acoustic data, optical data, olfactory data, or thermal data, as described above.

As further shown in FIG. 4, process 400 includes identifying, based on the powder bed laser fusion additive manufacturing emission data, one or more additive manufacturing object defects (block 420). For example, the device may identify based on the powder bed laser fusion additive manufacturing emission data, one or more additive manufacturing object defects, as described above.

As further shown in FIG. 4, process 400 includes transmitting, based on the one or more additive manufacturing object defects, an indication to adjust one or more powder bed laser fusion additive manufacturing parameters (block 430). For example, the device may transmit based on the one or more additive manufacturing object defects, an indication to adjust one or more powder bed laser fusion additive manufacturing parameters, as described above.

Process 400 may include additional aspects, such as any single aspect or any combination of aspects described below and/or in connection with one or more other processes described elsewhere herein.

In a first aspect, the one or more additive manufacturing object defects include one or more of keyhole pore formation, a layer bonding defect, a melt pool defect, surface irregularity, layer inconsistency, a structural integrity defect, uneven fusion, overheating, residual stress, or warping.

In a second aspect, alone or in combination with the first aspect, the one or more powder bed laser fusion additive manufacturing parameters include one or more of one or more laser beam parameters, one or more shield gas parameters, or one or more powder distribution parameters.

In a third aspect, alone or in combination with one or more of the first and second aspects, the one or more laser beam parameters include one or more of a laser beam power parameter, a laser beam focal length parameter, or a laser beam scan speed parameter, the one or more shield gas parameters include one or more of a shield gas flow parameter or a shield gas composition parameter, and the one or more powder distribution parameters include one or more of a powder distribution thickness parameter or a powder distribution feed rate parameter.

In a fourth aspect, alone or in combination with one or more of the first through third aspects, process 400 includes receiving, by the device, an indication of one or more laser beam parameters, and transmitting, by the device, based on the one or more laser beam parameters, an indication to adjust one or more emission sensor parameters, and receiving the powder bed laser fusion additive manufacturing emission data comprises receiving the powder bed laser fusion additive manufacturing emission data in accordance with the one or more emission sensor parameters.

In a fifth aspect, alone or in combination with one or more of the first through fourth aspects, the one or more laser beam parameters include one or more laser beam position parameters, one or more laser beam orientation parameters, or one or more laser beam intensity parameters.

In a sixth aspect, alone or in combination with one or more of the first through fifth aspects, identifying the one or more additive manufacturing object defects comprises identifying one or more additive manufacturing object defect zones associated with the one or more additive manufacturing object defects.

In a seventh aspect, alone or in combination with one or more of the first through sixth aspects, identifying the one or more additive manufacturing object defects comprises identifying the one or more additive manufacturing object defects using a machine learning model.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
receiving, by a device, powder bed laser fusion additive manufacturing emission data including two or more of acoustic data, optical data, olfactory data, or thermal data;
identifying, by the device, based on the powder bed laser fusion additive manufacturing emission data, one or more additive manufacturing object defects; and
transmitting, by the device, based on the one or more additive manufacturing object defects, an indication to adjust one or more powder bed laser fusion additive manufacturing parameters.

2. The computer-implemented method of claim 1, wherein the one or more additive manufacturing object defects include one or more of keyhole pore formation, a layer bonding defect, a melt pool defect, surface irregularity, layer inconsistency, a structural integrity defect, uneven fusion, overheating, residual stress, or warping.

3. The computer-implemented method of claim 1, wherein the one or more powder bed laser fusion additive manufacturing parameters include one or more of one or more laser beam parameters, one or more shield gas parameters, or one or more powder distribution parameters.

4. The computer-implemented method of claim 3, wherein the one or more laser beam parameters include one or more of a laser beam power parameter, a laser beam focal length parameter, or a laser beam scan speed parameter, the one or more shield gas parameters include one or more of a shield gas flow parameter or a shield gas composition parameter, and the one or more powder distribution parameters include one or more of a powder distribution thickness parameter or a powder distribution feed rate parameter.

5. The computer-implemented method of claim 1, further comprising:
receiving, by the device, an indication of one or more laser beam parameters; and
transmitting, by the device, based on the one or more laser beam parameters, an indication to adjust one or more emission sensor parameters, wherein receiving the powder bed laser fusion additive manufacturing emission data comprises:
receiving the powder bed laser fusion additive manufacturing emission data in accordance with the one or more emission sensor parameters.

6. The computer-implemented method of claim 5, wherein the one or more laser beam parameters include one or more laser beam position parameters, one or more laser beam orientation parameters, or one or more laser beam intensity parameters.

7. The computer-implemented method of claim 1, wherein identifying the one or more additive manufacturing object defects comprises:
identifying one or more additive manufacturing object defect zones associated with the one or more additive manufacturing object defects.

8. The computer-implemented method of claim 1, wherein identifying the one or more additive manufacturing object defects comprises:
identifying the one or more additive manufacturing object defects using a machine learning model.

9. A computer system comprising:
a processor set;
one or more computer-readable storage media; and
program instructions stored on the one or more computer-readable storage media to cause the processor set to perform operations comprising:
receiving an indication of one or more laser beam parameters;
transmitting, based on the one or more laser beam parameters, an indication to adjust one or more emission sensor parameters;
receiving, in accordance with the one or more emission sensor parameters, powder bed laser fusion additive manufacturing emission data including two or more of acoustic data, optical data, olfactory data, or thermal data;
identifying, based on the powder bed laser fusion additive manufacturing emission data, one or more additive manufacturing object defects; and
transmitting, based on the one or more additive manufacturing object defects, an indication to adjust one or more powder bed laser fusion additive manufacturing parameters.

10. The computer system of claim 9, wherein the one or more additive manufacturing object defects include one or more of keyhole pore formation, a layer bonding defect, a melt pool defect, surface irregularity, layer inconsistency, a structural integrity defect, uneven fusion, overheating, a structural integrity defect, residual stress, or warping.

11. The computer system of claim 9, wherein the one or more powder bed laser fusion additive manufacturing parameters include one or more of one or more laser beam parameters, one or more shield gas parameters, or one or more powder distribution parameters.

12. The computer system of claim 11, wherein the one or more laser beam parameters include one or more of a laser beam power parameter, a laser beam focal length parameter, or a laser beam scan speed parameter, the one or more shield gas parameters include one or more of a shield gas flow parameter or a shield gas composition parameter, and the one or more powder distribution parameters include one or more of a powder distribution thickness parameter or a powder distribution feed rate parameter.

13. The computer system of claim 9, wherein the one or more laser beam parameters include one or more laser beam position parameters, one or more laser beam orientation parameters, or one or more laser beam intensity parameters.

14. The computer system of claim 9, wherein identifying the one or more additive manufacturing object defects comprises:
identifying one or more additive manufacturing object defect zones associated with the one or more additive manufacturing object defects.

15. A computer program product comprising:
one or more computer-readable storage media; and
program instructions stored on the one or more computer-readable storage media to perform operations comprising:
receiving powder bed laser fusion additive manufacturing emission data including two or more of acoustic data, optical data, olfactory data, or thermal data;
identifying, based on the powder bed laser fusion additive manufacturing emission data, one or more additive manufacturing object defects using a machine learning model; and
transmitting, based on the one or more additive manufacturing object defects, an indication to adjust one or more powder bed laser fusion additive manufacturing parameters.

16. The computer program product of claim 15, wherein the one or more additive manufacturing object defects include one or more of keyhole pore formation, a layer bonding defect, a melt pool defect, surface irregularity, layer inconsistency, a structural integrity defect, uneven fusion, overheating, a structural integrity defect, residual stress, or warping.

17. The computer program product of claim 15, wherein the one or more powder bed laser fusion additive manufacturing parameters include one or more of one or more laser beam parameters, one or more shield gas parameters, or one or more powder distribution parameters.

18. The computer program product of claim 17, wherein the one or more laser beam parameters include one or more of a laser beam power parameter, a laser beam focal length parameter, or a laser beam scan speed parameter, the one or more shield gas parameters include one or more of a shield gas flow parameter or a shield gas composition parameter, and the one or more powder distribution parameters include one or more of a powder distribution thickness parameter or a powder distribution feed rate parameter.

19. The computer program product of claim 15, wherein the operations further comprise:
receiving an indication of one or more laser beam parameters; and
transmitting based on the one or more laser beam parameters, an indication to adjust one or more emission sensor parameters, wherein receiving the powder bed laser fusion additive manufacturing emission data comprises:
receiving the powder bed laser fusion additive manufacturing emission data in accordance with the one or more emission sensor parameters.

20. The computer program product of claim 19, wherein the one or more laser beam parameters include one or more laser beam position parameters, one or more laser beam orientation parameters, or one or more laser beam intensity parameters.
